(19) United States
(12) Patent Application Publication
(10) Pub. No.: US 2023/0212053 A1
(43) Pub. Date: Jul. 6, 2023

(54) FOAMED GLASS BODY, HEAT INSULATOR USING FOAMED GLASS BODY, AND METHOD FOR MANUFACTURING FOAMED GLASS BODY

(71) Applicant: YAZAKI ENERGY SYSTEM CORPORATION, Tokyo (JP)

(72) Inventor: Takuju Nakamura, Hamamatsu-shi (JP)

(21) Appl. No.: 18/184,617

(22) Filed: Mar. 15, 2023

Related U.S. Application Data
(63) Continuation of application No. PCT/JP2021/042822, filed on Nov. 22, 2021.

(30) Foreign Application Priority Data
Dec. 21, 2020 (JP) 2020-210922

(51) Int. Cl. C03B 19/08; E04B 1/78; C03C 11/00; C03C 17/00

(52) U.S. Cl. CPC C03B 19/08; E04B 1/78; C03C 11/007; C03C 17/00; E04B 2001/742

(57) ABSTRACT

A heat insulator includes a foamed glass body, and a hollow member that stores the foamed glass body in a hollow portion. The foamed glass body is composed of a silicate glass material containing R₂O compounds and RO compounds. In a case that a value A is a weight ratio (%) of the R₂O compounds in terms of oxides to the whole, and a value B is a weight ratio (%) of the RO compounds in terms of oxides to the whole, an absolute value of a value C obtained by an expression of value A−2.08×value B is 5.27 or less, or an absolute value of a value D obtained by an expression of value A−2.68×value B is 3.23 or less.

### CROSS-REFERENCE TO RELATED APPLICATIONS

This is a continuation of International Application No. PCT/JP2021/042822 filed on Nov. 22, 2021, and claims priority from Japanese Patent Application No. 2020-210922 filed on Dec. 21, 2020, the entire content of which is incorporated herein by reference.

### TECHNICAL FIELD

The present invention relates to a foamed glass body, a heat insulator using the foamed glass body, and a method for producing the foamed glass body.

### BACKGROUND ART

In the related art, a heat insulator that exhibits heat insulation performance has been known. The heat insulator is configured such that a foamed glass body is housed in, for example, an outer shell. In addition, examples of the heat insulator include a heat insulator in which an outer shell is made of a gas barrier material and the inside thereof is maintained in a vacuum state.

As an example, a heat insulator has been proposed in which a space between an inner tank and an outer tank covering the inner tank in an LNG tank with a double structure having the inner tank and the outer tank as an outer shell is filled with a perlite powder (foamed glass body) as a core material (see, for example, Patent Literature 1). In addition, in a refrigerator or the like which is required to have a lighter structure, an aluminum vapor-deposited resin film or the like is used as an outer shell.

### CITATION LIST

### Patent Literature

Patent Literature 1: JPH02-256999A

Patent Literature 2: JPS47-34607A

Patent Literature 3: JPS53-22520A

Patent Literature 4: JPS60-77145A

Patent Literature 5: JPS60-90943A

Patent Literature 6: JPS61-163148A

Patent Literature 7: JPS63-144144A

Patent Literature 8: JPH02-120255A

Patent Literature 9: JPH08-74168A

### SUMMARY OF INVENTION

Here, such a heat insulator needs to have a structure whose shape is not excessively changed under an external pressure. In particular, in a case where the heat insulator is used as a building material (for example, an outer wall), it is desired that the heat insulator is hardly deformed and has a high compressive strength even when a person leans on the outer shell or the heat insulator receives a wind pressure.

A heat insulator having a high compressive strength can be easily obtained as long as foaming is performed in a manner of reducing the foaming density. However, in this case, for example, the bulk density is more than 0.3 g/cm³.

There has been an attempt to perform firing and foaming so that the bulk density is 0.2 g/cm³ or less, focusing on weight reduction. For example, in any of Patent Literatures 2 to 9, a closed-cell body, which has a uniform thin wall, a relatively high strength, and a high foaming ratio, can be obtained by adding an alkaline component to facilitate elongation by softening and lowering a melting point, and performing firing and foaming. However, in these cases, a sufficient strength cannot be obtained because the glass walls of the cells are soft. For example, a foamed glass body having a bulk density of 0.1 g/cm³ is used as a reference, and the foamed glass body shrinks when a compression ratio under pressing of about 0.7 atm (pressing generated when a person leans or by a wind pressure) is more than 10%, and thus it is difficult to say that the foamed glass body has a sufficient compressive strength as a core material of a heat insulator.

As described above, in the related art, a foamed glass body having a light weight (bulk density of 0.2 g/cm³ or less) and a high compressive strength (compression ratio of 10% or less based on a bulk density of 0.1 g/cm³) cannot be obtained, or can be obtained only extremely accidentally.

The above problem is not limited to a building material application, and is also common to a tank, a refrigerator, or the like. For example, although the above description has been made on the assumption of the pressing generated when a person leans or by the wind pressure, it is desirable that the compressive strength is high because an object may come into contact with or collide with an inside of a tank or a refrigerator, and it is preferable that the foamed glass body has a light weight because the weight of a product is reduced.

The present invention has been made in order to solve such a problem, and an object of the present invention is to provide a foamed glass body having a lighter weight and a higher compressive strength, a heat insulator using the foamed glass body, and a method for producing the foamed glass body.

According to an aspect of the present invention, there is provided a foamed glass body having a bulk density of 0.2 g/cm³ or less under atmospheric pressure, the foamed glass body containing a silicate glass material containing R₂O compounds and RO compounds, in which an absolute value of a value C obtained by an expression of value A−2.08×value B is 5.27 or less, in which the value A is a weight ratio (%) of the R₂O compounds in terms of oxides to the whole, and the value B is a weight ratio (%) of the RO compounds in terms of oxides to the whole. The value A+the value B is 10.09 or less.

According to another aspect of the present invention, there is provided a foamed glass body having a bulk density of 0.2 g/cm³ or less under atmospheric pressure, the foamed glass body containing a silicate glass material containing R₂O compounds and RO compounds, in which an absolute value of a value D obtained by an expression of value A−2.68×value B is 3.23 or less, in which the value A is a weight ratio (%) of the R₂O compounds in terms of oxides to the whole, and the value B is a weight ratio (%) of the RO compounds in terms of oxides to the whole.

According to still another aspect of the present invention, there is provided a method for producing a foamed glass body whose foaming temperature is adjusted to have a bulk density of 0.2 g/cm³ or less in a state where atmospheric pressure is applied, the method including at least one of the following steps: a dealkalization step of performing a dealkalization treatment on an object that is a silicate glass material containing R₂O compounds and RO compounds, or a foamed body obtained by foaming the silicate glass material, to reduce a weight ratio (%) of the R₂O compounds in terms of oxides to the whole object; and an addition step of adding the RO compounds to the object, in which an absolute value of a value C obtained by an expression of value A−2.08×value B is 5.27 or less, in which the value A is the weight ratio (%) of the R₂O compounds in terms of oxides to the whole, and the value B is a weight ratio (%) of the RO compounds in terms of oxides to the whole.

According to yet still another aspect of the present invention, there is provided a method for producing a foamed glass body whose foaming temperature is adjusted to have a bulk density of 0.2 g/cm³ or less in a state where atmospheric pressure is applied, the method including at least one of the following steps: a dealkalization step of performing a dealkalization treatment on an object that is a silicate glass material containing R₂O compounds and RO compounds, or a foamed body obtained by foaming the silicate glass material, to reduce a weight ratio (%) of the R₂O compounds in terms of oxides to the whole object; and an addition step of adding the RO compounds to the object, in which an absolute value of a value D obtained by an expression of value A−2.68×value B is 3.23 or less, in which the value A is the weight ratio (%) of the R₂O compounds in terms of oxides to the whole, and the value B is a weight ratio (%) of the RO compounds in terms of oxides to the whole. The value A+the value B is 10.09 or less.

The present invention can provide a foamed glass body which has a lighter weight and an improved compressive strength, a heat insulator using the foamed glass body, and a method for producing the foamed glass body.

### BRIEF DESCRIPTION OF DRAWINGS

Exemplary embodiment(s) of the present invention will be described in detailed based on the following figures, wherein:

FIG. 1 is a schematic configuration diagram showing a heat insulator using a foamed glass body according to an embodiment of the present invention;

FIG. 2 is a process diagram showing a method for producing the foamed glass body according to the present embodiment;

FIG. 3 is a first table showing experimental samples and experimental results;

FIG. 4 is a second table showing experimental samples and experimental results;

FIG. 5 is a third table showing experimental samples and experimental results;

FIG. 6 is a fourth table showing experimental samples and experimental results;

FIG. 7 is a graph showing a correlation between a bulk density increasing rate during pressurization from 0 kPa to 102.8 kPa and an absolute value of a value obtained by subtracting a value that is 2.08 times a weight ratio (%) of RO compounds in terms of oxides from a weight ratio (%) of R₂O compounds in terms of oxides; and

FIG. 8 is a graph showing a correlation between a bulk density increasing rate during pressurization from 0 kPa to 201.2 kPa and an absolute value of a value obtained by subtracting a value that is 2.68 times the weight ratio (%) of RO compounds in terms of oxides from the weight ratio (%) of R₂O compounds in terms of oxides.

### DESCRIPTION OF EMBODIMENTS

Hereinafter, the present invention will be described along preferred embodiments. The present invention is not limited to the embodiments described below, and can be appropriately modified without departing from the scope of the present invention. In addition, in the embodiments described below, although illustration and description of a part of the configuration are omitted, it is needless to say that a known or well-known technique is appropriately applied to the details of the omitted technique within a range in which a contradiction does not occur with the contents described below.

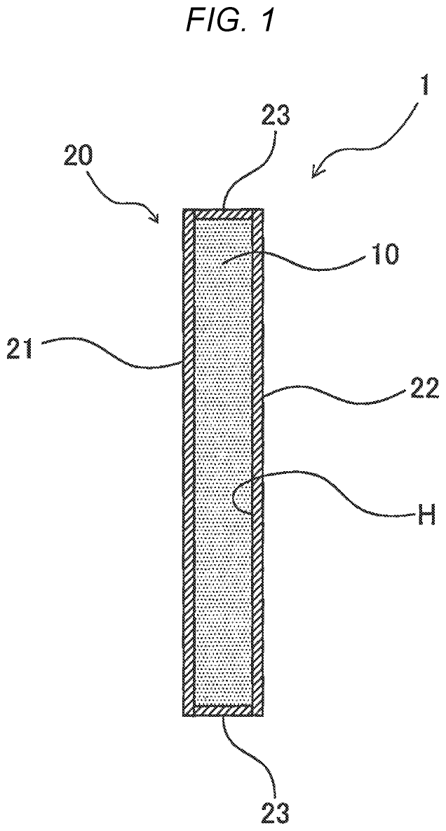

FIG. 1 is a schematic configuration diagram showing a heat insulator using a foamed glass body according to an embodiment of the present invention. As shown in FIG. 1, a heat insulator 1 includes a foamed glass body 10 and a hollow member 20. The foamed glass body 10 is housed in a hollow portion H which is an internal space of the hollow member 20. The hollow portion H may or may not be evacuated. In a case where evacuation is performed, the atmospheric pressure in the hollow portion H is preferably 1 kPa or lower. The heat insulator 1 is used as, for example, a part of a building material and is used in a normal temperature environment (an example of a temperature of −60° C. or higher).

The hollow member 20 includes, for example, outer shells 21 and 22 respectively corresponding to an indoor side and an outdoor side in a case where the heat insulator 1 is used as a building material, and a sealing member 23 that seals end portions of the outer shells 21 and 22. The outer shells 21 and 22 are made of, for example, a resin film having a gas barrier property or a metal film such as stainless steel. The sealing member 23 is also made of a material having a gas barrier property. The heat insulator 1 is not limited to the one that separates the indoor side and the outdoor side, and may be used as one that separates a certain space from another space in the room, or may be used as a box body, a wall body, or the like (regardless of the size) that covers a periphery of a member required to be kept warm within a temperature range such as a cold temperature or a high temperature. In the above description, the outer shells 21 and 22 and the sealing member 23 are separate bodies, and may be integrated with one another.

The foamed glass body 10 is made of a silicate glass material containing alkali metals (hereinafter, referred to as R₂O compounds) and alkaline earth metals (hereinafter, referred to as RO compounds), for example, a material obtained by chemically modifying (a dealkalization treatment or addition treatment of RO compounds) a perlite refined stone (obtained by crushing natural pitchstone, pearlstone, or obsidian) and then performing foaming, or a material obtained by chemically modifying (a dealkalization treatment or addition treatment of RO compounds) a perlite powder after foaming. The silicate glass material is not limited to the perlite refined stone or the foamed perlite powder thereof, and may be silica sand, volcanic ash, a waste glass powder, or foamed powders thereof

As a result of chemical modification, the foamed glass body 10 according to the present embodiment, a specific value (a value C described later) for the heat insulator 1 in which the hollow portion H is filled with air is 5.27 or less, more preferably 3.77 or less, and even more preferably 2.28 or less, and a specific value (a value D described later) for the heat insulator 1 in which the hollow portion H is evacuated is 3.23 or less, more preferably 2.14 or less, and even more preferably 1.04 or less. Accordingly, this is because the foamed glass body 10, which has a lighter weight, that is, has a bulk density of 0.2 g/cm³ or less, and has a high compressive strength under, for example, pressing of about 0.7 atm, can be easily obtained.

Note that the value C is calculated by an expression of value A−2.08×value B, and the value D is calculated by an expression of value A−2.65×value B, as will be described later. The value A is a weight ratio (%) of R₂O compounds in terms of oxides relative to the entire foamed glass body 10, and the value B is a weight ratio (%) of RO compounds in terms of oxides relative to the entire foamed glass body 10.

In addition, in the foamed glass body 10 according to the present embodiment, the total of the value A and the value B is preferably 7 or less (that is, the total of the weight ratios (%) of RO compounds and R₂O compounds in terms of oxides to the whole is 7% or less). This is because the reduced amounts of RO compounds and R₂O compounds increase a melting point of the foamed glass body 10, and therefore, the shrinkage can be 5% or less, and the heat resistance can be ensured even in exposure to, for example, a temperature of 900° C. for 6 hours or longer.

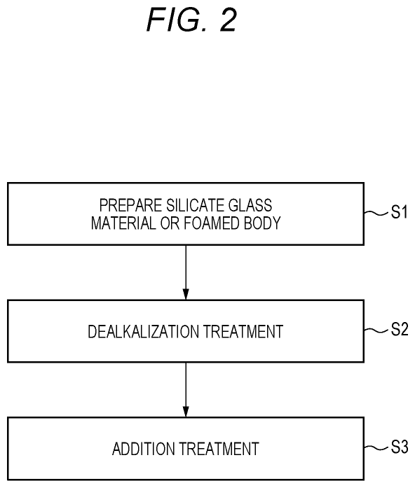

Next, a method for producing the foamed glass body 10 according to the present embodiment will be described. FIG. 2 is a process diagram showing the method for producing the foamed glass body 10 according to the present embodiment. As shown in FIG. 2, first, a silicate glass material containing R₂O compounds and RO compounds, or a foamed body obtained by foaming the silicate glass material is prepared (S1). The foamed glass body prepared here contains 5% or more of R₂O compounds, and has a value C of more than 5.27 and a value D of more than 3.23.

Next, an object prepared in step Si is subjected to a dealkalization treatment (S2). The dealkalization treatment is performed, for example, by charging the object into a container containing sulfuric acid and heating and holding the object. Accordingly, an alkali metal component in the object is removed.

Next, an addition treatment of RO compounds is performed on the object subjected to the dealkalization treatment in step S2 (S3). The addition treatment is performed by combining calcium hydroxide in a wet manner. In this treatment, a calcium hydroxide powder is mixed with the object, and distilled water is further added, followed by mixing, stirring, and drying, so that a fine powder of calcium hydroxide can adhere to the object.

Thereafter, the foamed glass body 10 is obtained through a necessary treatment such as a subsequent step (particularly, a foaming treatment based on heating in a case where the object is a silicate glass material before foaming).

In the present embodiment, the degree of removal of the alkali metal component can be adjusted by adjusting the concentration of sulfuric acid or the like, the capacity, the heating temperature, the heating time, and the like in step S2. In step S3, the addition degree of RO can be adjusted by adjusting the concentration of the calcium hydroxide powder relative to the distilled water, the stirring speed, the drying time, and the like.

In the present embodiment, by these adjustments, the value C of the foamed glass body 10 can be 5.27 or less, more preferably 3.77 or less, and even more preferably 2.28 or less, or the value D of the foamed glass body 10 can be 3.23 or less, more preferably 2.14 or less, and even more preferably 1.04 or less. Further, in the present embodiment, the total of the value A and the value B can be 7 or less by these adjustments.

In the above description, both the dealkalization treatment (S2) and the addition treatment (S3) are performed, but the present invention is not limited thereto. Only one of the dealkalization treatment (S2) and the addition treatment (S3) may be performed, or the addition treatment (S3) may be performed first in the case where both the above treatments are performed. If possible, the foaming treatment may be included in any one of steps S1 to S3.

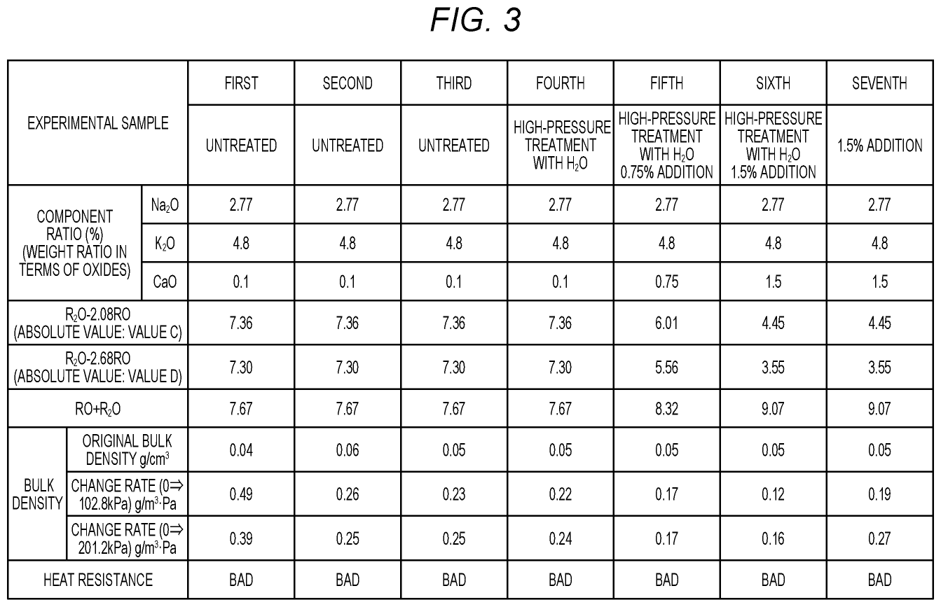

Next, experimental results and the like of the foamed glass body according to the present invention will be described. FIGS. 3 to 6 are tables showing experimental samples and experimental results.

First, 28 kinds of perlite refined stones, which contain R2O compounds and RO compounds in various ratios in a state where chemical modification was performed or in a state where chemical modification was not performed, were prepared in the following experiments. Next, each of the 28 kinds of perlite refined stones was charged into a furnace and heated to a high temperature to be foamed. The temperature during foaming was set to a high temperature (substantially the highest temperature, hereinafter referred to as an experimental temperature) at which the respective kinds of perlite refined stones were melted in the furnace and did not adhere to a furnace wall. Therefore, the 28 kinds of perlite refined stones were foamed as much as possible, and all of them had a bulk density of 0.2 g/cm³ or less as described later.

In the following experiments, the weight ratios (%) of R₂O compounds and RO compounds in terms of oxides were obtained by analyzing a surface composition with an energy dispersive X-ray analyzer (EX-350, manufactured by Horiba, Ltd.) attached to a scanning electron microscope (S-3400N, manufactured by Hitachi High-Tech Corporation), determining the concentration of an alkali metal component from the average values, and further converting the concentration of the alkali metal component into the concentration of oxides. In the samples, the surface composition analysis on 10 or more perlite grains was measured with chromatography. The observation was performed at an acceleration voltage of 15 kV.

In addition, a change rate (increasing rate) of the bulk density indicates a value calculated based on the bulk density obtained by the following procedures: the foamed perlite powder is charged into a container whose upper side is in an open state, a lid member is provided in an open portion, and a load equivalent when pressurized from 0 kPa to 102.8 kPa and a load equivalent when pressurized from 0 kPa to 201.2 kPa are applied to the lid member to press the lid member. The pressure of 102.8 kPa corresponds to the atmospheric pressure. For example, in a heat insulator whose internal space was filled with air, a load of about 0.7 atm was applied, and therefore, a change rate of the bulk density during pressurization to 1 atm (102.8 kPa) higher than 0.7 atm was calculated in advance. In addition, in a heat insulator whose internal space is in a vacuum state, the atmospheric pressure is applied to the foamed glass body in the heat insulator, the change rate of the bulk density during pressurization to about 2 atm (201.2 kPa) is calculated in advance.

Regarding the addition treatment of calcium oxide performed on experimental samples, an absolute amount of a calcium hydroxide powder (primary: manufactured by Kishida Chemical Co., Ltd.) having a particle diameter of 10 μm or less was mixed with about 50 g to 100 g of a perlite refined stone to have a target concentration (1.5% or 3% that is a weight ratio (%) in terms of oxides as a mixture), and distilled water was further added thereto such that a ratio of the mixture of the perlite refined stone and the calcium hydroxide to distilled water was 4:3, followed by mixing, stirring, and drying, so that a fine powder of calcium hydroxide adhered to a surface of pearlite. Specifically, the mixed solution was charged in a beaker and was heated by an external heating device such as a heater while being stirred at a rotational speed of about 200 rpm by a stirrer or the like, and moisture was completely volatilized over about 1 hour to 2 hours, thereby obtaining a perlite refined stone with a surface to which a fine calcium hydroxide powder substantially uniformly adhered.

In addition, the dealkalization treatment performed on the experimental samples was performed as follows. That is, a reaction container (outer cylinder SUS304, inner cylinder PTFE) having a capacity of 200 cc was filled with about 50 g of a perlite refined stone and 50 cc of sulfuric acid having a concentration of 85 wt %, and the reaction container was heated and held to attempt to remove the alkali metal component in pearlite (dealkalization treatment). The sulfuric acid used was adjusted to 85 wt % by mixing reagents (special grade reagent, manufactured by Kishida Chemical Co., Ltd.) respectively having concentrations of 98 wt % and 70 wt %. The reaction vessel filled with the perlite refined stone and sulfuric acid was heated and held in a muffle furnace at a predetermined temperature for a predetermined time. The perlite refined stone was taken out from the heated container, and the perlite refined stone was washed with distilled water until the pH of a washing waste liquid completely reached 7. The pearlite after washing was completely dried in a dryer to obtain a perlite refined stone after the dealkalization treatment.

In order to evaluate the progressing degree of the dealkalization treatment, the perlite refined stone subjected to the dealkalization treatment was observed with a scanning electron microscope (S-3400N, manufactured by Hitachi High-Tech Corporation). A surface of a perlite grain after dealkalization was observed with a scanning electron microscope, and the composition of the surface was analyzed with an attached energy dispersive X-ray analyzer (EX-350, manufactured by Horiba, Ltd.). The observation was performed at an acceleration voltage of 15 kV, followed by performing surface composition analysis on 10 or more perlite grains for each sample, and the concentration of the alkali metal component was determined from the average value and was further converted into the concentration of an oxide, thereby evaluating the progressing degree of dealkalization as “high”, “medium”, and “low”.

The heat insulator (foamed glass body) is required to deform slightly when a person leans on the heat insulator or the heat insulator receives a wind pressure. For example, as for a heat insulator having a bulk density of 0.1 g/cm³, a compression ratio under pressing of about 0.7 atm is desired to be 10% or less (that is, the bulk density increasing amount is 0.01 g/cm³ or less). In the following experimental examples, a heat insulator having a bulk density increasing amount of 0.01 g cm³ or less under pressing of about 0.7 atm was regarded as an acceptable product. Actually, a heat insulator having a bulk density increasing amount of 0.143 g/m³ Pa or less under pressing of 102.8 kPa in proportion was regarded as an acceptable product.

First, a first experimental sample shown in FIG. 3 is a ready-made perlite refined stone. As a result of subjecting the perlite refined stone for the first experimental sample to high-temperature foaming at an experimental temperature, the bulk density (an original bulk density, a bulk density under atmospheric pressure: the same applies hereinafter) was 0.04 g/cm³. As a result of measuring the perlite refined stone for the first experimental sample, a weight ratio (%) of sodium oxide in terms of oxides was 2.77, a weight ratio (%) of potassium oxide in terms of oxides was 4.8, and a weight ratio (%) of calcium oxide in terms of oxides was 0.1 (the components are the same even if the measurement was performed after foaming).

In the first experimental example in which the first experimental sample was foamed, the bulk density increasing rate when applying a load equivalent when pressurized from 0 kPa to 102.8 kPa was 0.49 g/m³·Pa. The bulk density increasing rate when applying a load equivalent when pressurized from 0 kPa to 201.2 kPa was 0.39 g/m³·Pa.

A second experimental sample is a ready-made perlite refined stone after being stored in a predetermined environment. As a result of subjecting the perlite refined stone for the second experimental sample to high-temperature foaming at an experimental temperature, the bulk density was 0.06 g/cm³. As a result of measuring the perlite refined stone for the second experimental sample, a weight ratio (%) of sodium oxide in terms of oxides was 2.77, a weight ratio (%) of potassium oxide in terms of oxides was 4.8, and a weight ratio (%) of calcium oxide in terms of oxides was 0.1 (the components are the same even if the measurement was performed after foaming).

In the second experimental example in which the second experimental sample was foamed, the bulk density increasing rate when applying a load equivalent when pressurized from 0 kPa to 102.8 kPa was 0.26 g/m³·Pa. The bulk density increasing rate when applying a load equivalent when pressurized from 0 kPa to 201.2 kPa was 0.25 g/m³·Pa.

A third experimental sample is a ready-made perlite refined stone after being stored in a predetermined environment for a storage time different from that of the second experimental sample. As a result of subjecting the perlite refined stone for the third experimental sample to high-temperature foaming at an experimental temperature, the bulk density was 0.05 g/cm³. As a result of measuring the perlite refined stone for the third experimental sample, a weight ratio (%) of sodium oxide in terms of oxides was 2.77, a weight ratio (%) of potassium oxide in terms of oxides was 4.8, and a weight ratio (%) of calcium oxide in terms of oxides was 0.1 (the components are the same even if the measurement was performed after foaming).

In the third experimental example in which the third experimental sample was foamed, the bulk density increasing rate when applying a load equivalent when pressurized from 0 kPa to 102.8 kPa was 0.23 g/m³·Pa. The bulk density increasing rate when applying a load equivalent when pressurized from 0 kPa to 201.2 kPa was 0.25 g/m³·Pa.

A fourth experimental sample is obtained by subjecting a ready-made perlite refined stone to a high-pressure treatment with H₂O. As a result of subjecting the perlite refined stone for the fourth experimental sample to high-temperature foaming at an experimental temperature, the bulk density was 0.05 g/cm³. As a result of measuring the perlite refined stone for the fourth experimental sample, a weight ratio (%) of sodium oxide in terms of oxides was 2.77, a weight ratio (%) of potassium oxide in terms of oxides was 4.8, and a weight ratio (%) of calcium oxide in terms of oxides was 0.1 (the components are the same even if the measurement was performed after foaming). That is, in the high-pressure treatment with H₂O, the components that are R₂O compounds and RO compounds are not changed.

In the fourth experimental example in which the fourth experimental sample was foamed, the bulk density increasing rate when applying a load equivalent when pressurized from 0 kPa to 102.8 kPa was applied was 0.22 g/m³·Pa. The bulk density increasing rate when applying a load equivalent when pressurized from 0 kPa to 201.2 kPa was applied was 0.24 g/m³·Pa.

A fifth experimental sample was obtained by subjecting a ready-made perlite refined stone to a high-pressure treatment with H₂O, and performing an addition treatment so that a weight ratio (%) of calcium oxide in terms of oxides was 0.75. As a result of subjecting the perlite refined stone for the fifth experimental sample to a high-temperature foaming at an experimental temperature, the bulk density was 0.05 g/cm³. As a result of measuring the perlite refined stone for the fifth experimental sample, a weight ratio (%) of sodium oxide in terms of oxides was 2.77, a weight ratio (%) of potassium oxide in terms of oxides was 4.8, and a weight ratio (%) of calcium oxide in terms of oxides was 0.75 (the components are the same even if the measurement was performed after foaming).

In the fifth experimental example in which the fifth experimental sample was foamed, the bulk density increasing rate when applying a load equivalent when pressurized from 0 kPa to 102.8 kPa was applied was 0.17 g/m³·Pa. The bulk density increasing rate when applying a load equivalent when pressurized from 0 kPa to 201.2 kPa was applied was 0.17 g/m³·Pa.

A sixth experimental sample was obtained by subjecting a ready-made perlite refined stone to a high-pressure treatment with H₂O, and performing an addition treatment so that a weight ratio (%) of calcium oxide in terms of oxides was 1.5. As a result of subjecting the perlite refined stone for the sixth experimental sample to high-temperature foaming at an experimental temperature, the bulk density was 0.05 g/cm³. As a result of measuring the perlite refined stone for the sixth experimental sample, a weight ratio (%) of sodium oxide in terms of oxides was 2.77, a weight ratio (%) of potassium oxide in terms of oxides was 4.8, and a weight ratio (%) of calcium oxide in terms of oxides was 1.5 (the components are the same even if the measurement was performed after foaming).

In the sixth experimental example in which the sixth experimental sample was foamed, the bulk density increasing rate when applying a load equivalent when pressurized from 0 kPa to 102.8 kPa was applied was 0.12 g/m³·Pa. The bulk density increasing rate when applying a load equivalent when pressurized from 0 kPa to 201.2 kPa was applied was 0.16 g/m³·Pa.

A seventh experimental sample was obtained by performing an addition treatment on a ready-made perlite refined stone so that a weight ratio (%) of calcium oxide in terms of oxides was 1.5. As a result of subjecting the perlite refined stone for the seventh experimental sample to a high-temperature foaming at an experimental temperature, the bulk density was 0.05 g/cm³. As a result of measuring the perlite refined stone for the seventh experimental sample, a weight ratio (%) of sodium oxide in terms of oxides was 2.77, a weight ratio (%) of potassium oxide in terms of oxides was 4.8, and a weight ratio (%) of calcium oxide in terms of oxides was 1.5 (the components are the same even if the measurement was performed after foaming).

In the seventh experimental example in which the seventh experimental sample was foamed, the bulk density increasing rate when applying a load equivalent when pressurized from 0 kPa to 102.8 kPa was applied was 0.19 g/m³·Pa. The bulk density increasing rate when applying a load equivalent when pressurized from 0 kPa to 201.2 kPa was applied was 0.27 g/m³·Pa.

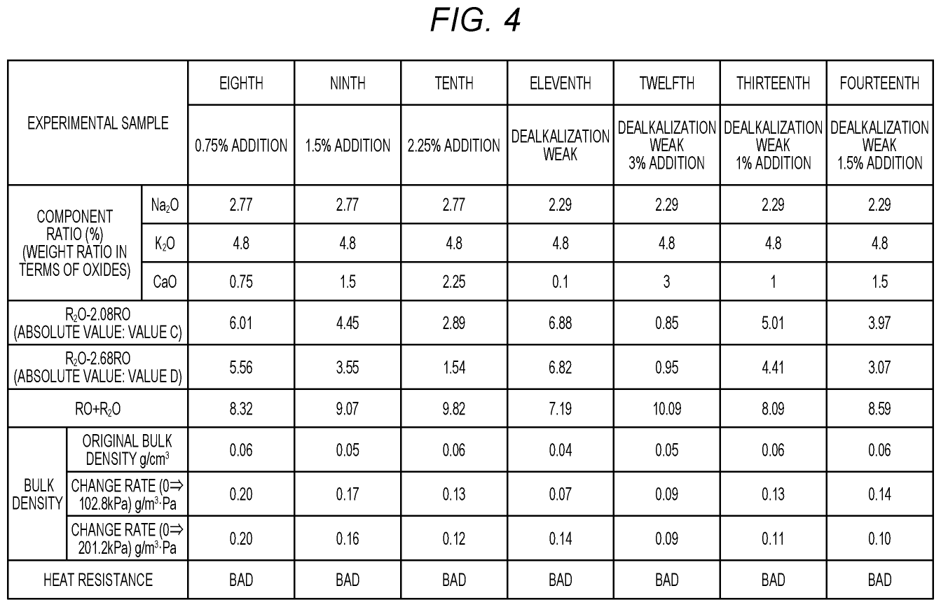

An eighth experimental sample shown in FIG. 4 was obtained by performing an addition treatment on a ready-made perlite refined stone so that a weight ratio (%) of calcium oxide in terms of oxides was 0.75. As a result of subjecting the perlite refined stone for the eighth experimental sample to a high-temperature foaming at an experimental temperature, the bulk density was 0.06 g/cm³. As a result of measuring the perlite refined stone for the eighth experimental sample, a weight ratio (%) of sodium oxide in terms of oxides was 2.77, a weight ratio (%) of potassium oxide in terms of oxides was 4.8, and a weight ratio (%) of calcium oxide in terms of oxides was 0.75 (the components are the same even if the measurement was performed after foaming).

In the eighth experimental example in which the eighth experimental sample was foamed, the bulk density increasing rate when applying a load equivalent when pressurized from 0 kPa to 102.8 kPa was applied was 0.20 g/m³·Pa. The bulk density increasing rate when applying a load equivalent when pressurized from 0 kPa to 201.2 kPa was applied was 0.20 g/m³·Pa.

A ninth experimental sample was obtained by performing an addition treatment on a ready-made perlite refined stone so that a weight ratio (%) of calcium oxide in terms of oxides was 1.5. As a result of subjecting the perlite refined stone for the ninth experimental sample to high-temperature foaming at an experimental temperature, the bulk density was 0.05 g/cm³. As a result of measuring the perlite refined stone for the ninth experimental sample, a weight ratio (%) of sodium oxide in terms of oxides was 2.77, a weight ratio (%) of potassium oxide in terms of oxides was 4.8, and a weight ratio (%) of calcium oxide in terms of oxides was 1.5 (the components are the same even if the measurement was performed after foaming).

In the ninth experimental example in which the ninth experimental sample was foamed, the bulk density increasing rate when applying a load equivalent when pressurized from 0 kPa to 102.8 kPa was applied was 0.17 g/m³·Pa. The bulk density increasing rate when applying a load equivalent when pressurized from 0 kPa to 201.2 kPa was applied was 0.16 g/m³·Pa.

A tenth experimental sample was obtained by performing an addition treatment on a ready-made perlite refined stone so that a weight ratio (%) of calcium oxide in terms of oxides was 2.25. As a result of subjecting the perlite refined stone for the tenth experimental sample to high-temperature foaming at an experimental temperature, the bulk density was 0.06 g/cm³. As a result of measuring the perlite refined stone for the tenth experimental sample, a weight ratio (%) of sodium oxide in terms of oxides was 2.77, a weight ratio (%) of potassium oxide in terms of oxides was 4.8, and a weight ratio (%) of calcium oxide in terms of oxides was 2.25 (the components are the same even if the measurement was performed after foaming).

In the tenth experimental example in which the tenth experimental sample was foamed, the bulk density increasing rate when applying a load equivalent when pressurized from 0 kPa to 102.8 kPa was applied was 0.13 g/m³·Pa. The bulk density increasing rate when applying a load equivalent when pressurized from 0 kPa to 201.2 kPa was applied was 0.12 g/m³·Pa.

An eleventh experimental sample is obtained by performing a dealkalization treatment (weak) on a ready-made perlite refined stone. As a result of subjecting the perlite refined stone for the eleventh experimental sample to high-temperature foaming at an experimental temperature, the bulk density was 0.04 g/cm³. As a result of measuring the perlite refined stone for the eleventh experimental sample, a weight ratio (%) of sodium oxide in terms of oxides was 2.29, a weight ratio (%) of potassium oxide in terms of oxides was 4.8, and a weight ratio (%) of calcium oxide in terms of oxides was 0.1 (the components are the same even if the measurement was performed after foaming).

In the eleventh experimental example in which the eleventh experimental sample was foamed, the bulk density increasing rate when applying a load equivalent when pressurized from 0 kPa to 102.8 kPa was applied was 0.07 g/m³ Pa. The bulk density increasing rate when applying a load equivalent when pressurized from 0 kPa to 201.2 kPa was applied was 0.14 g/m³·Pa.

A twelfth experimental sample was obtained by performing a dealkalization treatment (weak) on a ready-made perlite refined stone, and performing an addition treatment on the perlite refined stone so that a weight ratio (%) of calcium oxide in terms of oxides was 3. As a result of subjecting the perlite refined stone for the twelfth experimental sample to high-temperature foaming at an experimental temperature, the bulk density was 0.05 g/cm³. As a result of measuring the perlite refined stone for the twelfth experimental sample, a weight ratio (%) of sodium oxide in terms of oxides was 2.29, a weight ratio (%) of potassium oxide in terms of oxides was 4.8, and a weight ratio (%) of calcium oxide in terms of oxides was 3 (the components are the same even if the measurement was performed after foaming).

In the twelfth experimental example in which the twelfth experimental sample was foamed, the bulk density increasing rate when applying a load equivalent when pressurized from 0 kPa to 102.8 kPa was applied was 0.09 g/m³·Pa. The bulk density increasing rate when applying a load equivalent when pressurized from 0 kPa to 201.2 kPa was applied was 0.09 g/m³·Pa.

A thirteenth experimental sample was obtained by performing a dealkalization treatment (weak) on a ready-made perlite refined stone, and performing an addition treatment on the perlite refined stone so that a weight ratio (%) of calcium oxide in terms of oxides was 1. As a result of subjecting the perlite refined stone for the thirteenth experimental sample to high-temperature foaming at an experimental temperature, the bulk density was 0.06 g/cm³. As a result of measuring the perlite refined stone for the thirteenth experimental sample, a weight ratio (%) of sodium oxide in terms of oxides was 2.29, a weight ratio (%) of potassium oxide in terms of oxides was 4.8, and a weight ratio (%) of calcium oxide in terms of oxides was 1 (the components are the same even if the measurement was performed after foaming).

In the thirteenth experimental example in which the thirteenth experimental sample was foamed, the bulk density increasing rate when applying a load equivalent when pressurized from 0 kPa to 102.8 kPa was 0.13 g/m³·Pa. The bulk density increasing rate when applying a load equivalent when pressurized from 0 kPa to 201.2 kPa was applied was 0.11 g/m³·Pa.

A fourteenth experimental sample was obtained by performing a dealkalization treatment (weak) on a ready-made perlite refined stone, and performing an addition treatment on the perlite refined stone so that a weight ratio (%) of calcium oxide in terms of oxides was 1.5. As a result of subjecting the perlite refined stone for the fourteenth experimental sample to high-temperature foaming at an experimental temperature, the bulk density was 0.06 g/cm³. As a result of measuring the perlite refined stone for the fourteenth experimental sample, a weight ratio (%) of sodium oxide in terms of oxides was 2.29, a weight ratio (%) of potassium oxide in terms of oxides was 4.8, and a weight ratio (%) of calcium oxide in terms of oxides was 1.5 (the components are the same even if the measurement was performed after foaming).

In the fourteenth experimental example in which the fourteenth experimental sample was foamed, the bulk density increasing rate when applying a load equivalent when pressurized from 0 kPa to 102.8 kPa was applied was 0.14 g/m³·Pa. The bulk density increasing rate when applying a load equivalent when pressurized from 0 kPa to 201.2 kPa was applied was 0.10 g/m³·Pa.

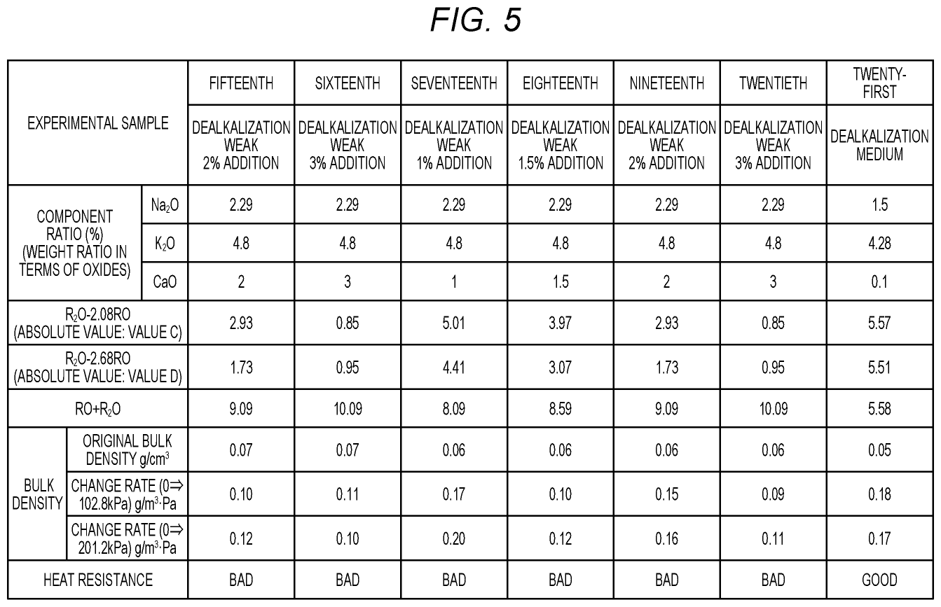

A fifteenth experimental sample shown in FIG. 5 was obtained by performing a dealkalization treatment (weak) on a ready-made perlite refined stone, and performing an addition treatment on the perlite refined stone so that a weight ratio (%) of calcium oxide in terms of oxides was 2. As a result of subjecting the perlite refined stone for the fifteenth experimental sample to high-temperature foaming at an experimental temperature, the bulk density was 0.07 g/cm³. As a result of measuring the perlite refined stone for the fifteenth experimental sample, a weight ratio (%) of sodium oxide in terms of oxides was 2.29, a weight ratio (%) of potassium oxide in terms of oxides was 4.8, and a weight ratio (%) of calcium oxide in terms of oxides was 2 (the components are the same even if the measurement was performed after foaming).

In the fifteenth experimental example in which the fifteenth experimental sample was foamed, the bulk density increasing rate when applying a load equivalent when pressurized from 0 kPa to 102.8 kPa was applied was 0.10 g/m³·Pa. The bulk density increasing rate when applying a load equivalent when pressurized from 0 kPa to 201.2 kPa was applied was 0.12 g/m³·Pa.

A sixteenth experimental sample was obtained by performing a dealkalization treatment (weak) on a ready-made perlite refined stone, and performing an addition treatment on the perlite refined stone so that a weight ratio (%) of calcium oxide in terms of oxides was 3. As a result of subjecting the perlite refined stone for the sixteenth experimental sample to high-temperature foaming at an experimental temperature, the bulk density was 0.07 g/cm³. As a result of measuring the perlite refined stone for the sixteenth experimental sample, a weight ratio (%) of sodium oxide in terms of oxides was 2.29, a weight ratio (%) of potassium oxide in terms of oxides was 4.8, and a weight ratio (%) of calcium oxide in terms of oxides was 3 (the components are the same even if the measurement was performed after foaming).

In the sixteenth experimental example in which the sixteenth experimental sample was foamed, the bulk density increasing rate when applying a load equivalent when pressurized from 0 kPa to 102.8 kPa was applied was 0.11 g/m³·Pa. The bulk density increasing rate when applying a load equivalent when pressurized from 0 kPa to 201.2 kPa was applied was 0.10 g/m³·Pa.

A seventeenth experimental sample was obtained by performing a dealkalization treatment (weak) on a ready-made perlite refined stone, and performing an addition treatment on the perlite refined stone so that a weight ratio (%) of calcium oxide in terms of oxides was 1. As a result of subjecting the perlite refined stone for the seventeenth experimental sample to high-temperature foaming at an experimental temperature, the bulk density was 0.06 g/cm³. As a result of measuring the perlite refined stone for the seventeenth experimental sample, a weight ratio (%) of sodium oxide in terms of oxides was 2.29, a weight ratio (%) of potassium oxide in terms of oxides was 4.8, and a weight ratio (%) of calcium oxide in terms of oxides was 1 (the components are the same even if the measurement was performed after foaming).

In the seventeenth experimental example in which the seventeenth experimental sample was foamed, the bulk density increasing rate when applying a load equivalent when pressurized from 0 kPa to 102.8 kPa was applied was 0.17 g/m³·Pa. The bulk density increasing rate when applying a load equivalent when pressurized from 0 kPa to 201.2 kPa was applied was 0.20 g/m³·Pa.

An eighteenth experimental sample was obtained by performing a dealkalization treatment (weak) on a ready-made perlite refined stone, and performing an addition treatment on the perlite refined stone so that a weight ratio (%) of calcium oxide in terms of oxides was 1.5. As a result of subjecting the perlite refined stone for the eighteenth experimental sample to high-temperature foaming at an experimental temperature, the bulk density was 0.06 g/cm³. As a result of measuring the perlite refined stone for the eighteenth experimental sample, a weight ratio (%) of sodium oxide in terms of oxides was 2.29, a weight ratio (%) of potassium oxide in terms of oxides was 4.8, and a weight ratio (%) of calcium oxide in terms of oxides was 1.5 (the components are the same even if the measurement was performed after foaming).

In the eighteenth experimental example in which the eighteenth experimental sample was foamed, the bulk density increasing rate when applying a load equivalent when pressurized from 0 kPa to 102.8 kPa was applied was 0.10 g/m³·Pa. The bulk density increasing rate when applying a load equivalent when pressurized from 0 kPa to 201.2 kPa was applied was 0.12 g/m³·Pa.

A nineteenth experimental sample was obtained by performing a dealkalization treatment (weak) on a ready-made perlite refined stone, and performing an addition treatment on the perlite refined stone so that a weight ratio (%) of calcium oxide in terms of oxides was 2. As a result of subjecting the perlite refined stone for the nineteenth experimental sample to high-temperature foaming at an experimental temperature, the bulk density was 0.06 g/cm³. As a result of measuring the perlite refined stone for the nineteenth experimental sample, a weight ratio (%) of sodium oxide in terms of oxides was 2.29, a weight ratio (%) of potassium oxide in terms of oxides was 4.8, and a weight ratio (%) of calcium oxide in terms of oxides was 2 (the components are the same even if the measurement was performed after foaming).

In the nineteenth experimental example in which the nineteenth experimental sample was foamed, the bulk density increasing rate when applying a load equivalent when pressurized from 0 kPa to 102.8 kPa was applied was 0.15 g/m³·Pa. The bulk density increasing rate when applying a load equivalent when pressurized from 0 kPa to 201.2 kPa was applied was 0.16 g/m³·Pa.

A twentieth experimental sample was obtained by performing a dealkalization treatment (weak) on a ready-made perlite refined stone, and performing an addition treatment on the perlite refined stone so that a weight ratio (%) of calcium oxide in terms of oxides was 3. As a result of subjecting the perlite refined stone for the twentieth experimental sample to high-temperature foaming at an experimental temperature, the bulk density was 0.06 g/cm³. As a result of measuring the perlite refined stone for the twentieth experimental sample, a weight ratio (%) of sodium oxide in terms of oxides was 2.29, a weight ratio (%) of potassium oxide in terms of oxides was 4.8, and a weight ratio (%) of calcium oxide in terms of oxides was 3 (the components are the same even if the measurement was performed after foaming).

In the twentieth experimental example in which the twentieth experimental sample was foamed, the bulk density increasing rate when applying a load equivalent when pressurized from 0 kPa to 102.8 kPa was applied was 0.09 g/m³·Pa. The bulk density increasing rate when applying a load equivalent when pressurized from 0 kPa to 201.2 kPa was applied was 0.11 g/m³·Pa.

A twenty-first experimental sample was obtained by performing a dealkalization treatment (medium) on a ready-made perlite refined stone. As a result of subjecting the perlite refined stone for the twenty-first experimental sample to high-temperature foaming at an experimental temperature, the bulk density was 0.05 g/cm³. As a result of measuring the perlite refined stone for the twenty-first experimental sample, a weight ratio (%) of sodium oxide in terms of oxides was 1.5, a weight ratio (%) of potassium oxide in terms of oxides was 4.28, and a weight ratio (%) of calcium oxide in terms of oxides was 0.1 (the components are the same even if the measurement was performed after foaming).

In the twenty-first experimental example in which the twenty-first experimental sample was foamed, the bulk density increasing rate when applying a load equivalent when pressurized from 0 kPa to 102.8 kPa was applied was 0.18 g/m³·Pa. The bulk density increasing rate when applying a load equivalent when pressurized from 0 kPa to 201.2 kPa was applied was 0.17 g/m³·Pa.

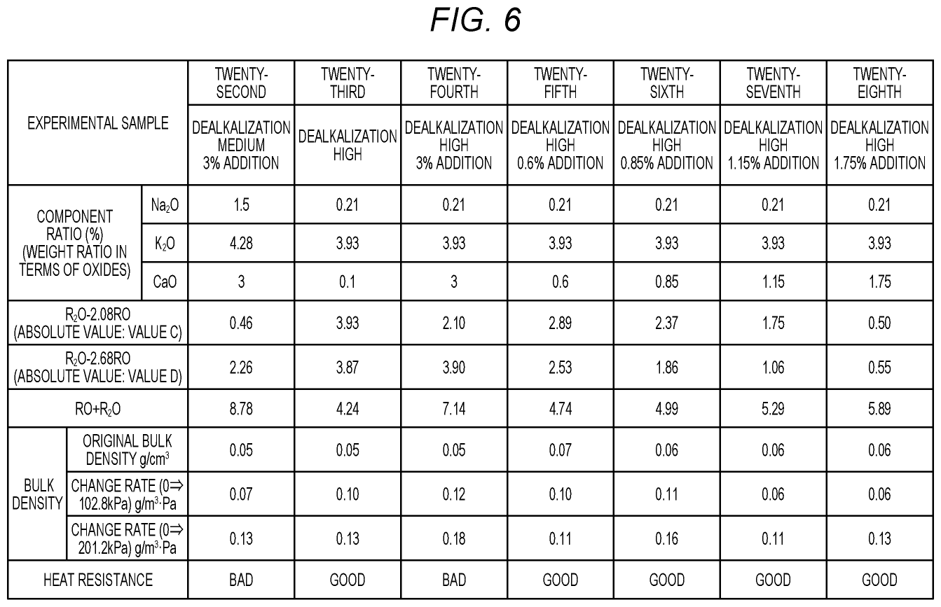

A twenty-second experimental sample shown in FIG. 6 was obtained by performing a dealkalization treatment (medium) on a ready-made perlite refined stone, and performing an addition treatment on the perlite refined stone so that a weight ratio (%) of calcium oxide in terms of oxides was 3. As a result of subjecting the perlite refined stone for the twenty-second experimental sample to high-temperature foaming at an experimental temperature, the bulk density was 0.05 g/cm³. As a result of measuring the perlite refined stone for the twenty-second experimental sample, a weight ratio (%) of sodium oxide in terms of oxides was 1.5, a weight ratio (%) of potassium oxide in terms of oxides was 4.28, and a weight ratio (%) of calcium oxide in terms of oxides was 3 (the components are the same even if the measurement was performed after foaming).

In the twenty-second experimental example in which the twenty-second experimental sample was foamed, the bulk density increasing rate when applying a load equivalent when pressurized from 0 kPa to 102.8 kPa was applied was 0.07 g/m³·Pa. The bulk density increasing rate when applying a load equivalent when pressurized from 0 kPa to 201.2 kPa was applied was 0.13 g/m³·Pa.

A twenty-third experimental sample is obtained by performing a dealkalization treatment (high) on a ready-made perlite refined stone. As a result of subjecting the perlite refined stone for the twenty-third experimental sample to high-temperature foaming at an experimental temperature, the bulk density was 0.05 g/cm³. As a result of measuring the perlite refined stone for the twenty-third experimental sample, a weight ratio (%) of sodium oxide in terms of oxides was 0.21, a weight ratio (%) of potassium oxide in terms of oxides was 3.93, and a weight ratio (%) of calcium oxide in terms of oxides was 0.1 (the components are the same even if the measurement was performed after foaming).

In the twenty-third experimental example in which the twenty-third experimental sample was foamed, the bulk density increasing rate when applying a load equivalent when pressurized from 0 kPa to 102.8 kPa was applied was 0.10 g/m³·Pa. The bulk density increasing rate when applying a load equivalent when pressurized from 0 kPa to 201.2 kPa was applied was 0.13 g/m³·Pa.

A twenty-fourth experimental sample was obtained by performing a dealkalization treatment (high) on a ready-made perlite refined stone and performing an addition treatment on the perlite refined stone so that a weight ratio (%) of calcium oxide in terms of oxides was 3. As a result of subjecting the perlite refined stone for the twenty-fourth experimental sample to high-temperature foaming at an experimental temperature, the bulk density was 0.05 g/cm³. As a result of measuring the perlite refined stone of the twenty-fourth experimental sample, a weight ratio (%) of sodium oxide in terms of oxides was 0.21, a weight ratio (%) of potassium oxide in terms of oxides was 3.93, and a weight ratio (%) of calcium oxide in terms of oxides was 3 (the components are the same even if the measurement was performed after foaming).

In the twenty-fourth experimental example in which the twenty-fourth experimental sample was foamed, the bulk density increasing rate when applying a load equivalent when pressurized from 0 kPa to 102.8 kPa was applied was 0.12 g/m³·Pa. The bulk density increasing rate when applying a load equivalent when pressurized from 0 kPa to 201.2 kPa was applied was 0.18 g/m³·Pa.

A twenty-fifth experimental sample was obtained by performing a dealkalization treatment (high) on a ready-made perlite refined stone and performing an addition treatment on the perlite refined stone so that a weight ratio (%) of calcium oxide in terms of oxides was 0.6. As a result of subjecting the perlite refined stone for the twenty-fifth experimental sample to high-temperature foaming at an experimental temperature, the bulk density was 0.07 g/cm³. As a result of measuring the perlite refined stone for the twenty-fifth experimental sample, a weight ratio (%) of sodium oxide in terms of oxides was 0.21, a weight ratio (%) of potassium oxide in terms of oxides was 3.93, and a weight ratio (%) of calcium oxide in terms of oxides was 0.6 (the components are the same even if the measurement was performed after foaming).

In the twenty-fifth experimental example in which the twenty-fifth experimental sample was foamed, the bulk density increasing rate when applying a load equivalent when pressurized from 0 kPa to 102.8 kPa was applied was 0.10 g/m³·Pa. The bulk density increasing rate when applying a load equivalent when pressurized from 0 kPa to 201.2 kPa was applied was 0.11 g/m³·Pa.

A twenty-sixth experimental sample was obtained by performing a dealkalization treatment (high) on a ready-made perlite refined stone and performing an addition treatment on the perlite refined stone so that a weight ratio (%) of calcium oxide in terms of oxides was 0.85. As a result of subjecting the perlite refined stone for the twenty-sixth experimental sample to high-temperature foaming at an experimental temperature, the bulk density was 0.06 g/cm³. As a result of measuring the perlite refined stone for the twenty-sixth experimental sample, a weight ratio (%) of sodium oxide in terms of oxides was 0.21, a weight ratio (%) of potassium oxide in terms of oxides was 3.93, and a weight ratio (%) of calcium oxide in terms of oxides was 0.85 (the components are the same even if the measurement was performed after foaming).

In the twenty-sixth experimental example in which the twenty-sixth experimental sample was foamed, the bulk density increasing rate when applying a load equivalent when pressurized from 0 kPa to 102.8 kPa was applied was 0.11 g/m³·Pa. The bulk density increasing rate when applying a load equivalent when pressurized from 0 kPa to 201.2 kPa was applied was 0.16 g/m³·Pa.

A twenty-seventh experimental sample was obtained by performing a dealkalization treatment (high) on a ready-made perlite refined stone and performing an addition treatment on the perlite refined stone so that a weight ratio (%) of calcium oxide in terms of oxides was 1.15. As a result of subjecting the perlite refined stone for the twenty-seventh experimental sample to high-temperature foaming at an experimental temperature, the bulk density was 0.06 g/cm³. As a result of measuring the perlite refined stone for the twenty-seventh experimental sample, a weight ratio (%) of sodium oxide in terms of oxides was 0.21, a weight ratio (%) of potassium oxide in terms of oxides was 3.93, and a weight ratio (%) of calcium oxide in terms of oxides was 1.15 (the components are the same even if the measurement was performed after foaming).

In the twenty-seventh experimental example in which the twenty-seventh experimental sample was foamed, the bulk density increasing rate when applying a load equivalent when pressurized from 0 kPa to 102.8 kPa was applied was 0.06 g/m³·Pa. The bulk density increasing rate when applying a load equivalent when pressurized from 0 kPa to 201.2 kPa was applied was 0.11 g/m³·Pa.

A twenty-eighth experimental sample was obtained by performing a dealkalization treatment (high) on a ready-made perlite refined stone and performing an addition treatment on the perlite refined stone so that a weight ratio (%) of calcium oxide in terms of oxides was 1.75. As a result of subjecting the perlite refined stone for the twenty-eighth experimental sample to high-temperature foaming at an experimental temperature, the bulk density was 0.06 g/cm³. As a result of measuring the perlite refined stone for the twenty-eighth experimental sample, a weight ratio (%) of sodium oxide in terms of oxides was 0.21, a weight ratio (%) of potassium oxide in terms of oxides was 3.93, and a weight ratio (%) of calcium oxide in terms of oxides was 1.75 (the components are the same even if the measurement was performed after foaming).

In the twenty-eighth experimental example in which the twenty-eighth experimental sample was foamed, the bulk density increasing rate when applying a load equivalent when pressurized from 0 kPa to 102.8 kPa was applied was 0.06 g/m³Pa. The bulk density increasing rate when applying a load equivalent when pressurized from 0 kPa to 201.2 kPa was applied was 0.13 g/m³·Pa.

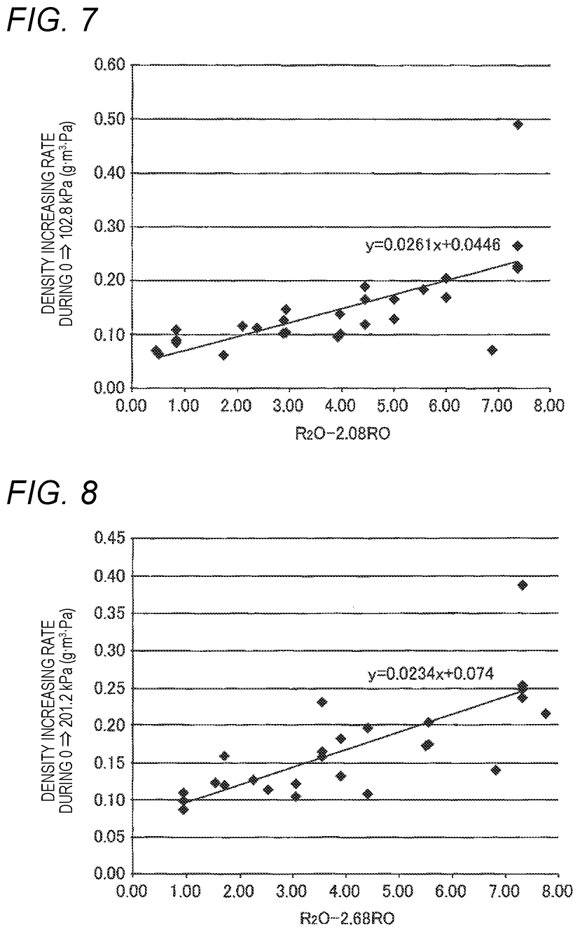

FIG. 7 is a graph showing a correlation between a bulk density increasing rate during pressurization from 0 kPa to 102.8 kPa and an absolute value of a value obtained by subtracting a value that is 2.08 times a weight ratio (%) of RO compounds in terms of oxides from a weight ratio (%) of R₂O compounds in terms of oxides. FIG. 8 is a graph showing a correlation between a bulk density increasing rate during pressurization from 0 kPa to 201.2 kPa and an absolute value of a value obtained by subtracting a value that is 2.68 times the weight ratio (%) of RO compounds in terms of oxides from the weight ratio (%) of R₂O compounds in terms of oxides.

The 28 experimental results as described above were intensively studied. As a result, it was found that the correlation was high in a case where the vertical axis represented a bulk density increasing rate when pressurized from 0 kPa to 102.8 kPa, and the horizontal axis represented an absolute value of a value (that is, the value C) obtained by subtracting a value that is 2.08 times the weight ratio (%) of the RO compounds in terms of oxides (that is, the value B) from the weight ratio (%) of the R₂O compounds in terms of oxides (that is, the value A). Specifically, when the bulk density increasing rate is defined as y, and the value C is defined as x, y can be approximated as y=0.0261x+0.0446, and the correlation coefficient is 0.6859, which indicates a strong correlation.

The value C was 7.36, 7.36, 7.36, 7.36, 6.01, 4.45, 4.45, 6.01, 4.45, 2.89, 6.88, 0.85, 5.01, 3.97, 2.93, 0.85, 5.01, 3.97, 2.93, 0.85, 5.57, 0.46, 3.93, 2.10, 2.89, 2.37, 1.75, and 0.50 in this order from the first experimental example to the twenty-eighth experimental example.

Similarly, as a result of intensive studies on the 28 experimental results, it was found that the correlation was high in a case where the vertical axis represented a bulk density increasing rate when pressurized from 0 kPa to 201.2 kPa, and the horizontal axis represented an absolute value of a value (that is, the value D) obtained by subtracting a value that is 2.68 times the weight ratio (%) of the RO compounds in terms of oxides (that is, the value B) from the weight ratio (%) of the R₂O compounds in terms of oxides (that is, the value A). Specifically, when the bulk density increasing rate is defined as y, and the value D is defined as x, y can be approximated as y=0.0234x+0.074, and the correlation coefficient is 0.7391, which indicates a very strong correlation.

The value D was 7.30, 7.30, 7.30, 7.30, 5.56, 3.55, 3.55, 5.56, 3.55, 1.54, 6.82, 0.95, 4.41, 3.07, 1.73, 0.95, 4.41, 3.07, 1.73, 0.95, 5.51, 2.26, 3.87, 3.90, 2.53, 1.86, 1.06, and 0.55 in this order from the first experimental example to the twenty-eighth experimental example.

As described above, from the above correlation, it was found that regarding the heat insulator whose internal space is filled with air, the compressive strength is easily ensured by controlling the value C, and regarding the heat insulator in which the internal space is in a vacuum state, the compressive strength is easily ensured by controlling the value D.

Here, with a heat insulator having a foamed glass body with a bulk density of 0.1 g/cm³ as a reference, a target value is set such that a compression ratio under pressing of, for example, about 0.7 atm is within 10% (that is, a bulk density increasing amount is 0.01 g/cm³ or less). In this case, in the heat insulator whose internal space is filled with air, the bulk density increasing rate per unit pressure is desirably 0.143 g/m³·Pa or less (pass line). In the heat insulator whose internal space is in a vacuum state, the bulk density increasing rate per unit pressure is desirably 0.124 g/m³·Pa or less (acceptable line) in consideration of further application of atmospheric pressure.

Assuming that the variation in the bulk density increasing rate relative to an approximate straight line shown in FIGS. 7 and 8 follows the normal distribution, based on a standard normal distribution table, it was found that about 20% of the products (the heat insulators whose internal space is filled with air) satisfied the pass line when the value C was set to 5.27 or less, about 50% of the products satisfied the pass line when the value C was set to 3.77 or less, and about 80% of the products satisfied the pass line when the value C was set to 2.28 or less. Similarly, it was found that about 20% of the products (heat insulators whose internal space was in a vacuum state) satisfied the pass line when the value D was set to 3.23 or less, about 50% of the products satisfied the pass line when the value D was set to 2.14 or less, and about 80% of the products satisfied the pass line when the value D was set to 1.04 or less.

From the above description, it was found that, by controlling the value C and the value D, a foamed glass body having a light weight (bulk density of 0.2 g/cm³ or less) and a high compressive strength (satisfying the pass line), which has not been obtained in the related art, can be obtained.

The perlite refined stone in the experimental example is heated and foamed at the experimental temperature, and has an original bulk density within a range of about 0.04 g/cm³ or more and 0.07 g/cm³ or less. The perlite refined stone may be produced by being foamed at a temperature lower than the experimental temperature within a range in which the original bulk density is not more than 0.2 g/cm³. Here, the compressive strength of the foamed glass body tends to increase as the bulk density increases. That is, in the case where the value C and the value D are satisfied, foaming at a temperature lower than the experimental temperature results in an increase in an acceptable product ratio.

Furthermore, a heat resistance test was also performed on the 28 experimental examples. In the heat resistance test, a SUS container was filled with a perlite powder at 1 atm, and the pearlite powder was heated at 900° C. for 2 hours in an electric furnace and then slowly cooled and taken out, then heated at 950° C. for 2 hours and then slowly cooled and taken out, finally heated at 1000° C. for 2 hours and then slowly cooled and taken out, and the volumes before heating and after heating at 1000° C. were measured. As a result of the measurement, a sample in which a shrinkage of 5% or more was observed was evaluated as Bad, and a sample in which a shrinkage of 5% or more was not observed was evaluated as Good.

Regarding 28 kinds of experimental samples, the total of the weight ratio (%) (value A) of R₂O compounds in terms of oxides and the weight ratio (%) (value B) of RO compounds in terms of oxides was 7.67, 7.67, 7.67, 7.67, 8.32, 9.07, 9.07, 8.32, 9.07, 9.82, 7.19, 10.09, 8.09, 8.59, 9.09, 10.09, 8.09, 8.59, 9.09, 10.09, 5.58, 8.78, 4.24, 7.14, 4.74, 4.99, 5.29, and 5.89 in this order from the first experimental example to the twenty-eighth experimental example.

As described above, in the twenty-first, twenty-third, and twenty-fifth to twenty-eighth experimental examples which were evaluated as Good in the heat resistance test, the value A+the value B was 5.58, 4.24, 4.74, 4.99, 5.29, and 5.89. That is, it was found that when the value A+the value B was 5.89 or less, higher heat resistance was satisfied.

Although not illustrated, even for the twenty-eighth experimental example in which a value of the value A+the value B is the highest among the experimental examples indicating Good, the shrinkage was not 5%, and there was a certain degree of margin until the shrinkage was 5%. Therefore, it was expected that the shrinkage fell within 5% up to 7% in calculation, and it was also found that the shrinkage fell within 5% when at least the value of the value A+the value B was 7 or less.

In addition, although the description of the experimental examples was omitted, it was found that even in the case of silica sand, volcanic ash, or a waste glass powder, when the value C and the value D were controlled in the same manner, a foamed glass body having a lighter weight and a higher compressive strength can be obtained. In particular, regarding untreated silica sand, volcanic ash, and a waste glass powder not subjected to chemical modification, the value C was more than 5.27 and the value D was more than 3.23, and a foamed glass body having a lighter weight and a higher compressive strength cannot be obtained, or can be obtained only extremely accidentally. However, it was found that when the value C was 5.27 or less, more preferably 3.77 or less, and even more preferably 2.28 or less, and the value D was 3.23 or less, more preferably 2.14 or less, and even more preferably 1.04 or less, acceptable products of a predetermined level or more could be produced.

As described above, according to the foamed glass body 10 in the present embodiment, when the absolute value of the value C is 5.27 or less for the foamed glass body 10 having a bulk density of 0.2 g/cm³ or less under atmospheric pressure, in the heat insulator 1 in which the foamed glass body is housed in the outer shell, a shrinkage rate generated, for example, when a person leans or a wind pressure is received can easily fall within a target value, and the foamed glass body 10 having a lighter weight and a higher compressive strength can be obtained expectedly (with a probability of a certain degree or more).

In addition, the foamed glass body 10 having a lighter weight and a higher compressive strength can be obtained with a higher probability by setting the absolute value of the value C to 3.77 or less. The foamed glass body 10 having a lighter weight and a higher compressive strength can be obtained with a very high probability by setting the absolute value of the value C to 2.28 or less.

According to the foamed glass body 10 in the present embodiment, when the absolute value of the value D is 3.23 or less for the foamed glass body 10 having a bulk density of 0.2 g/cm³ or less under atmospheric pressure, in the foamed glass body 1 in which the outer shell is brought into a vacuum state and the foamed glass body 10 is housed, a shrinkage rate generated, for example, when a person leans or a wind pressure is received can easily fall within a target value, and the foamed glass body 10 having a lighter weight and a higher compressive strength can be obtained expectedly (with a probability of a certain degree or more).

In addition, the foamed glass body 10 having a lighter weight and a higher compressive strength can be obtained with a higher probability by setting the absolute value of the value D to 2.14 or less. The foamed glass body 10 having a lighter weight and a higher compressive strength can be obtained with a very high probability by setting the absolute value of the value D to 1.04 or less.

When the weight ratios (%) of the R₂O compounds and the RO compounds in terms of oxides are reduced by setting the total of the value A and the value B to be 7% or less, the melting point of the foamed glass body 10 is increased, and even when exposed to a temperature of 900° C. for 6 hours or longer, the shrinkage can be 5% or less, and heat resistance can be ensured.

Regarding the foamed glass body 10 having a bulk density of 0.2 g/cm³ or less under atmospheric pressure, the bulk density increasing rate when the external pressure is changed from 0 kPa to 102.8 kPa is 0.143 g/m³·Pa or less, so that in the heat insulator 1 with air in the outer shell, the shrinkage can easily fall within a target value, for example, when a person leans or a wind pressure is received, and the foamed glass body 10 having a lighter weight and a higher compressive strength can be obtained expectedly (with a probability of a certain degree or more).

Regarding the foamed glass body 10 having a bulk density of 0.2 g/cm³ or less under atmospheric pressure, the bulk density increasing rate when the external pressure is changed from 0 kPa to 201.2 kPa is 0.124 g/m³·Pa or less, so that in the heat insulator 1 in which the outer shell is brought into a vacuum state and the foamed glass body 10 is housed, the shrinkage can easily fall within a target value, for example, when a person leans or a wind pressure is received, and the foamed glass body 10 having a lighter weight and a higher compressive strength can be obtained.

According to the heat insulator 1 in the present embodiment, the foamed glass body 10 is housed, so that the heat insulator 1 whose compressive strength is improved can be provided.

According to the method for producing the foamed glass body 10 in the present embodiment, the foaming temperature is adjusted and a dealkalization treatment is performed on the silicate glass material or the foamed glass body 10 or RO compounds are added so that the bulk density is 0.2 g/cm³ or less in a state in which atmospheric pressure is applied, and as a result, the absolute value of the value C is 5.27 or less. Therefore, with the chemical modification for the silicate glass material or the foamed glass body whose value C does not satisfy the condition, the absolute value of the value C can be 5.27 or less, and the shrinkage can fall within the target value in a case where the silicate glass material or the foamed glass body is used in the heat insulator 1 with air in the hollow portion H. Therefore, the foamed glass body 10 which has a lighter weight and a higher compressive strength can be produced.

In addition, according to the method for producing the foamed glass body 10 in the present embodiment, the foaming temperature is adjusted and a dealkalization treatment is performed on the silicate glass material or the foamed glass body or RO compounds are added so that the bulk density is 0.2 g/cm³ or less in a state in which atmospheric pressure is applied, and as a result, the absolute value of the value D is 3.23 or less. Therefore, with the chemical modification for the silicate glass material or the foamed glass body whose value D does not satisfy the condition, the absolute value of the value D can be 3.23 or less, and the shrinkage can fall within the target value in a case where the silicate glass material or the foamed glass body used in the heat insulator 1 whose hollow portion H is evacuated. Therefore, the foamed glass body 10 which has a lighter weight and a higher compressive strength can be produced.

Although the present invention has been described above based on the embodiments, the present invention is not limited to the above embodiments, and modifications may be made without departing from the spirit of the present invention, or known or well-known techniques may be combined as appropriate within the scope of the present invention.

In the present embodiment, the dealkalization treatment includes a step of high-temperature holding, so that foaming may be performed by the high-temperature holding.

The dealkalization treatment may be performed by a high-temperature dry blooming treatment. In addition, in the dealkalization treatment, the treatment may be performed with dilute sulfuric acid or dilute nitric acid which is a liquid under a pressurization environment, and the treatment may be performed while maintaining the water content.

The present application is based on Japanese Patent Application No. 2020-210922 filed on Dec. 21, 2020, the contents of which are incorporated herein by reference.

1. A foamed glass body having a bulk density of 0.2 g/cm³ or less under atmospheric pressure, the foamed glass body comprising:
a silicate glass material containing R₂O compounds and RO compounds,
wherein an absolute value of a value C obtained by an expression of value A−2.08×value B is 5.27 or less, in which the value A is a weight ratio (%) of the R₂O compounds in terms of oxides to the whole, and the value B is a weight ratio (%) of the RO compounds in terms of oxides to the whole, and
wherein the value A+the value B is 10.09 or less.

2. The foamed glass body according to claim 1,
wherein the absolute value of the value C obtained by the expression of value A−2.08×value B is 3.77 or less.

3. The foamed glass body according to claim 2,
wherein the absolute value of the value C obtained by the expression of value A−2.08×value B is 2.28 or less.

4. A foamed glass body having a bulk density of 0.2 g/cm³ or less under atmospheric pressure, the foamed glass body comprising:
a silicate glass material containing R₂O compounds and RO compounds,
wherein an absolute value of a value D obtained by an expression of value A−2.68×value B is 3.23 or less, in which the value A is a weight ratio (%) of the R₂O compounds in terms of oxides to the whole, and the value B is a weight ratio (%) of the RO compounds in terms of oxides to the whole, and
wherein the value A+the value B is 10.09 or less.

5. The foamed glass body according to claim 4,
wherein the absolute value of the value D obtained by the expression of value A−2.68×value B is 2.14 or less.

6. The foamed glass body according to claim 5,
wherein the absolute value of the value D obtained by the expression of value A−2.68×value B is 1.04 or less.

7. The foamed glass body according to claim 1,
wherein a total of the value A and the value B is 7 or less.

8. A heat insulator comprising:
the foamed glass body according to claim 1; and
a hollow member configured to house the foamed glass body in a hollow portion.

9. A method for producing a foamed glass body whose foaming temperature is adjusted to have a bulk density of 0.2 g/cm³ or less in a state where atmospheric pressure is applied, the method comprising at least one of the following steps:
a dealkalization step of performing a dealkalization treatment on an object that is a silicate glass material containing R₂O compounds and RO compounds, or a foamed body obtained by foaming the silicate glass material, to reduce a weight ratio (%) of the R₂O compounds in terms of oxides to the whole object; and
an addition step of adding the RO compounds to the object,
wherein an absolute value of a value C obtained by an expression of value A−2.08×value B is 5.27 or less, in which the value A is the weight ratio (%) of the R₂O compounds in terms of oxides to the whole, and the value B is a weight ratio (%) of the RO compounds in terms of oxides to the whole, or
an absolute value of a value D obtained by an expression of value A−2.68×value B is 3.23 or less, in which the value A is the weight ratio (%) of the R₂O compounds in terms of oxides to the whole, and the value B is a weight ratio (%) of the RO compounds in terms of oxides to the whole, and
wherein the value A+the value B is 10.09 or less.
